(19) United States
(12) Patent Application Publication
(10) Pub. No.: US 2026/0212222 A1
(43) Pub. Date: Jul. 23, 2026

(54) METHOD FOR VERIFYING A DEFINED CLASSIFICATION OF A LOG FILE OF A DRILLING OPERATION

(71) Applicant: MATRIX JVCO LTD trading as AIQ, Abu Dhabi (AE)

(72) Inventors: Abdallah BENZINE, Abu Dhabi (AE); Youssef TAMAAZOUSTI, Abu Dhabi (AE); Arghad ARNAOUT, Abu Dhabi (AE); Imane CHRAIBI, Abu Dhabi (AE); Mohamed AMRI, Abu Dhabi (AE); Ridha ZEGDANE, Abu Dhabi (AE); Aravind Unnikrishnan SATHIKUMARI, Abu Dhabi (AE); Rahil MUKADAM, Abu Dhabi (AE); Luis Ramon Baptista PERAZA, Abu Dhabi (AE); Juma Lulaiman AL SHAMSI, Abu Dhabi (AE); Abdul Salam AWAD, Abu Dhabi (AE); Mohamed Ahmed ALNUAIMI, Abu Dhabi (AE); Suhail Mohammed AL AMERI, Abu Dhabi (AE); Paulinus Abhyudaya BIMASTIANTO, Abu Dhabi (AE); Shreepad Purushottam KHAMBETE, Abu Dhabi (AE)

(73) Assignee: MATRIX JVCO LTD trading as AIQ, Abu Dhabi (AE)

(21) Appl. No.: 19/139,092

(22) PCT Filed: Dec. 13, 2022
(86) PCT No.: PCT/IB2022/062105

§ 371 Date: Jun. 13, 2025

(51) Int. Cl. G06N 5/04; G06F 16/16; G06F 18/241

(52) U.S. Cl. CPC G06N 5/04; G06F 16/16; G06F 18/241

(57) ABSTRACT

A computer-implemented method for verifying a defined classification of a log file of a drilling operation comprises the steps of (i) receiving the log file of the drilling operation comprising at least a description of the drilling operation and the defined classification, (ii) generating, using a trained artificial intelligence, Al, model, a predicted classification based on at least the description of the drilling operation; (iii) verifying a correspondence of the defined classification and the predicted classification, and indicating a result of the verifying step.

### FIELD OF THE INVENTION

The present disclosure relates to a computer-implemented method, a data processing device and a computer program for verifying a defined classification of a log file of a drilling operation. In addition, the present disclosure relates to a training method of an artificial intelligence model for use in classifying a drilling operation and an artificial intelligence model for use in classifying a drilling operation.

### BACKGROUND

Every day, for thousands of wells, drilling activities and operations are reported in the oil and gas industry. These reports are called Daily Drilling Reports (DDR) and are generated by drilling supervisors on the rig on a daily basis. Drilling supervisors who are in charge of operational activities have to write textual reports of all events and activities that occur on that day. These reports contain, for instance, findings, unfavorable events and summaries for every phase of the drilling. The report is a reference for well life cycle and can be used by all drilling stakeholders, even several years after the end of the well to contextualize any event or activity which had happened in the past.

Analyzing and classifying a free-text data report is crucial and challenging. In some companies, the drilling supervisor describes the drilling operations and classifies them into codes and subcodes. As this classification is crucial (in terms of uniformization, consistency and indexation), a quality control engineer must check all the classified codes and correct them if necessary. In fact, the codes may not be consistent, may not be entered correctly or may not match the drilling operation.

Every day, many reports are written to describe in detail the important operations that took place during the day for each well.

These reports are a gold mine of information, written in an open text format by different authors (e.g., drilling supervisors) and must be reviewed and corrected (by a dedicated quality control team) to ensure consistency and homogeneity.

This step is important because it guarantees a quick and efficient access to the information later on, especially by other digital solutions, and at the same time tedious and costly since it is done manually.

Given the infinite number of activities, combination of activities to report in one hand, and the way they are reported in a DDR, namely using a description, it looks impossible to fully automate the report classification process.

WO 2022/146415 proposes an automatically correction of a drilling data with predictive modeling implemented in a drilling data analytics engine. The engine comprises a drilling data quality analyzer which segregates drilling data into “good” drilling data and “bad” drilling data that has missing, incomplete, or incorrect entries. Missing entries can comprise data entries with no values. Incomplete or incorrect data entries can be determined by the drilling data quality analyzer using one or more data quality rules. For each bad data entry in the bad drilling data, the drilling data analytics engine preprocess drilling data attribute values for the corresponding task not including the drilling data attribute value for the bad data entry and inputs the preprocessed drilling data attribute values into a trained predictive model. Even if this solution improves the reporting quality, it does not check the uniformization and the consistency of the drilling data.

Against this background, there is a need for a method for accurate and reliable verifying a defined classification of a log file of a drilling operation allowing for consistency in the classification of the reported drilling operations.

### SUMMARY OF THE INVENTION

The above-mentioned problem is at least partly solved by a computer-implemented method according to aspect 1, by a computer-implemented method according to aspect 9, by an AI model according to aspect 17, by a data processing device according to aspect 20 and a computer program according to aspect 21.

A 1^{st} aspect of the present invention refers to a computer-implemented method for verifying a defined classification of a log file of a drilling operation, the method comprises the steps of: receiving the log file of the drilling operation comprising at least a description of the drilling operation and the defined classification; generating, using a trained artificial intelligence, AI, model, a predicted classification based on at least the description of the drilling operation; verifying a correspondence of the defined classification and the predicted classification; and indicating a result of the verifying.

Generating a predicted classification based on a description of the drilling operation comprised in a log file of the drilling operation and verifying a correspondence of the defined classification and the predicted classification allow verifying the consistency of the log file, and in particular the defined classification. The result of the verifying is indicated to a user, for example to a quality control engineer who could control and correct, if necessary, the defined classification or validate the predicted classification, in particularly when the indication mentions a probably wrong defined classification. This may lead to better uniformity of the classification of drilling operation descriptions and a faster verification process (in particular for the quality control engineer).

According to a 2^{nd} aspect in the 1^{st} aspect, the defined classification comprises a defined mapping from the description of the drilling operation to at least one operation code of a plurality of operation codes describing drilling operations; and the predicted classification comprises a predicted mapping from the description of the drilling operation to at least one operation code of the plurality of operation codes describing drilling operations.

The defined classification and the predicted classification comprise respectively a defined and a predicted mapping from the description of the drilling operation to at least one operation code of a plurality of operation codes describing drilling operations. In fact, operation codes may specify specific drilling operation that occur during the exploration and production process.

According to a 3^{rd} aspect in the 2^{nd} aspect, the operation code comprises a code and a subcode; and the step of generating the predicted classification comprises the steps of: predicting the code, Cₚ, from the description of the drilling operation, using a first model; and predicting the subcode, SCₚ, based on the description of the drilling operation and the predicted code, using a second model.

Generating a code and a subcode of the code may improve the classification consistency and facilitate predictions.

According to a 4^{th} aspect in any one of the 2^{nd} to 3^{rd} aspect, the step of verifying comprises: comparing the at least one operation code of the defined classification to the at least one operation code of the predicted classification.

By comparing the operation code of the defined classification to the operation code of the predicted classification, a verification of the defined classification may be performed. In particular, if the comparison indicates that the operation code of the defined classification is the same as the predicted classification, then it may be interpreted that the defined classification is probably correct. If not, it may be interpreted that the defined classification is probably incorrect.

According to a 5^{th} aspect in the 3^{rd} and 4^{th} aspects, the step of comparing the at least one operation code of the defined classification to the at least one operation code of the predicted classification comprises the steps of: comparing a code C_{d} of the defined classification to the code Cₚ of the predicted classification; and comparing a subcode SC_{d} of the defined classification to the subcode SCₚ of the predicted classification

According to a 6^{th} aspect in any one of the 1^{st} to 5^{th} aspect, the step of indicating the result comprises: sending a warning message when there is no correspondence in the verification step.

Sending a warning message when there is no correspondence between the defined classification and the predicted classification may highlight that the defined classification needs to be verified.

According to a 7^{th} aspect in any one of the 1^{st} to 6^{th} aspect, the method further comprises validating the predicted classification by a user when there is no correspondence in the verification step, based on at least the description of the drilling operation and the predicted classification.

According to an 8^{th} aspect in any one of the 1^{st} to 7^{th} aspect, the description of the drilling operation includes a raw natural language text description made by an operator.

An 9^{th} aspect refers to a computer-implemented method for training an artificial intelligence model for use in classifying a drilling operation, the method comprising a step of receiving input training data to train the model comprising two sets of training data: a first set of training data D_{H} comprising at least one log file describing a drilling operation and a controlled classification, and a second set of training data D_{D} comprising at least one recent log file describing a drilling operation and a controlled classification.

According to a 10^{th} aspect in the preceding aspect, a number of log files of the first set of training data D_{H} is equal to a number of recent log files of the second set of training data D_{D}.

According to an 11^{th} aspect in any one of the 9^{th} to 10^{th} aspect, the training of the AI model comprises: training a first model to predict a code Cₚ from the description of the drilling operation and a controlled code of the controlled classification of the drilling operation of the at least one log file; and training a second model to predict a subcode SCₚ from the description of the drilling operation, the controlled code and a controlled subcode of the controlled classification of the drilling operation of the at least one log file.

According to a 12^{th} aspect in any one of the 9^{th} to 11^{th} aspect, the training of the AI model includes a natural language processing to simulate error and/or amend the description of the drilling operation reported in the at least one log file.

According to a 13^{th} aspect in the preceding aspect, the natural language processing comprises data augmentation.

According to a 14^{th} aspect in any one of the 1^{st} to 13^{th} aspect, the description of the drilling operation comprises at least one of an operation description comprising at least one keyword/label, a drilling phase, a duration of the drilling operation, a summary of a period of time of the drilling operation and some codes and/or subcodes.

According to a 15^{th} aspect in any one of the 1^{st} to 8^{th} aspect, the AI model has been trained according to the method of any one of the 9^{th} to 14^{th} aspect.

According to a 16^{th} aspect in any one of the 1^{st} to 8^{th} aspect, the method comprises determining that new training data is available and training the model according to the method of any one of the 9^{th} to 13^{th} aspect using the new input data.

A 17^{th} aspect refers to a AI model for use in classifying a drilling operation, the model has a hierarchical structure comprising a first model to predict a code mapping a description of a drilling operation and a second model to predict a subcode mapping the description of the drilling operation and the code, the AI model being trained according to the method of any one of the 9^{th} to 13^{th} aspect.

According to a 18^{th} aspect in the preceding aspect, the second model comprise a plurality of specific second models, each specific second model being specific to a code predicted by the first model.

According to a 19^{th} aspect in any one of the 17^{th} to 18^{th} aspect, the AI model is implemented by a neural network, preferably a transformer network.

A 20^{th} aspect refers to a data processing device comprising means configured to perform the method according to the 1^{st} to 8^{th} or 9^{th} to 16^{th} aspect.

A 21^{st} aspect refers to a computer program comprising instructions, which when executed by a computer, causes the computer to perform the method according to the 1^{st} to 8^{th} or 9^{th} to 16^{th} aspect.

### BRIEF DESCRIPTION OF THE DRAWINGS

Various aspects of the present invention are described in more detail in the following by reference to the accompanying figures without the present invention being limited to the embodiments of these figures.

FIG. 1 illustrates an overview of a method for verifying a defined classification of a log file of a drilling operation according to aspects of the present invention.

FIG. 2 illustrates a flow chart of a method for verifying a defined classification of a log file of a drilling operation according to aspects of the present invention.

FIG. 3 illustrates input data that may be used by an AI model for use in classifying a drilling operation as input and output data generated by the AI model according to aspects of the present invention.

FIG. 4 illustrates training data to train an AI model for use in classifying a drilling operation according to aspects of the present invention.

FIG. 5 illustrates an overview of the workflow of a verification of a defined classification of a log file of a drilling operation and of a training of an AI model for use in classifying a drilling operation according to aspects of the present invention.

FIG. 6 illustrates an overview of an improved workflow according to aspects of the present invention.

### DETAILED DESCRIPTION

In the following, certain aspects of the present invention are described in more detail.

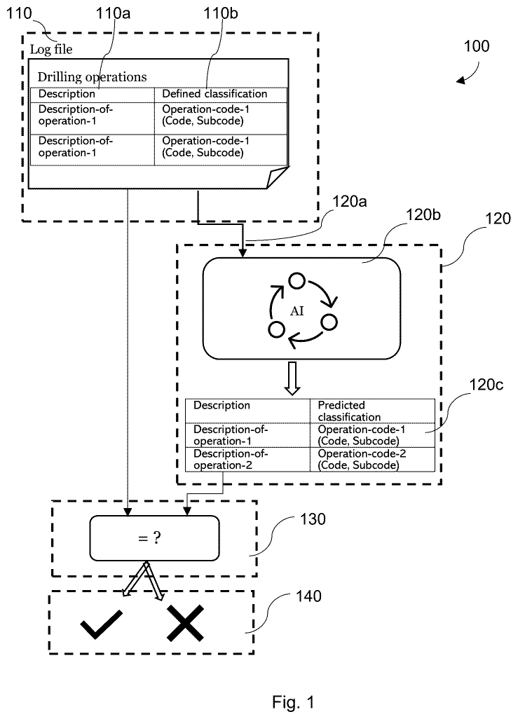

FIG. 1 illustrates an overview of an algorithm 100 according to aspects of the present invention used for verifying a defined classification of a log file of a drilling operation. The algorithm 100 is based on a workflow, namely an artificial intelligence, AI, workflow 120. The input data on which the method operates is referred to as log file of a drilling operation 110.

A log file of a drilling operation 110 may be a Daily Drilling Report (DDR) and may be generated by an operator, namely a drilling supervisor. A log file 110 on which a classification may be verified is associated with a drilling operation. The log file may comprise at least a description of the drilling operation 110a and a defined classification 110b. The description of the drilling operation 110a may be realized by a drilling supervisor who is in charge of operational activities. The drilling supervisor may write in the log file a description of the drilling operation to report events and activities that occur, for example during a day. The description of the drilling operation may comprise, for instance, findings, unfavorable events and summaries for a phase of the drilling operation. The description of the drilling operation may include a natural language text description.

Based on the description of the drilling operation, the drilling supervisor may classify the drilling operation to obtain a defined classification 110b. The defined classification may comprise a defined mapping from the description of the drilling operation to at least one operation code of a plurality of operation codes describing drilling operations. Indeed, an operation code may identify a specific activity that occur during the exploration and production process. The operation code may comprise a code C_{d} and a subcode SC_{d}. The subcode may be a subcode of the code identified for the drilling operation to allow a more accurate and precise classification of the drilling operation.

As illustrated in FIG. 1, the log file of the drilling operation 110 comprises two descriptions of the drilling operation and for each description of the drilling operation, a defined classification including a code and a subcode. However, the log file of the drilling operation may comprise more than two descriptions of the drilling operation or at the very least, at least one description of the drilling operation.

While the AI workflow 120 operates on the log file of the drilling operation, it is possible that it only operates on certain parts of the log file. For example, the IA workflow 120 may only use a part of the log file (e.g., the description of the drilling operation 110a) as input data 120a. The input data 120a may be inputted into an artificial intelligence, AI, model 120b for generating a predicted classification 120C based on the description of the drilling operation. The predicted classification may comprise a predicted mapping from the description of the drilling operation to at least one operation code of the plurality of operation codes describing drilling operations. The operation code of the predicted classification may comprise a code Cₚ and a subcode SCₚ.

Based on the defined classification 110b and the predicted classification 120c, a verification of a correspondence of the predicted classification and the defined classification may be carried out 130 and a result of the verifying may be indicated 140. The verification of the correspondence may comprise comparing the operation code of the defined classification to the operation code of the predicted classification. The verification may also comprise comparing the code C_{d} of the defined classification to the code Cₚ of the predicted classification and comparing the subcode SC_{d} of the defined classification to the subcode SCₚ of the predicted classification.

A user, namely the quality control engineer, may further validate the predicted classification, in particular, when there is no correspondence in the verification step or when the indication of the result indicates that there is no correspondence in the verification step, based on at least the description of the drilling operation and the predicted classification. In this case, the validation may be done manually.

The algorithm has the advantage of improving the quality control process efficiency and the process of verification of log files. In addition, by indicating the result of the verifying, the quality control engineer may manually verify only log files for which the indication mentions that there is no correspondence between the defined classification and the predicted classification. Therefore, the verification of log files may be automated and therefore accelerated.

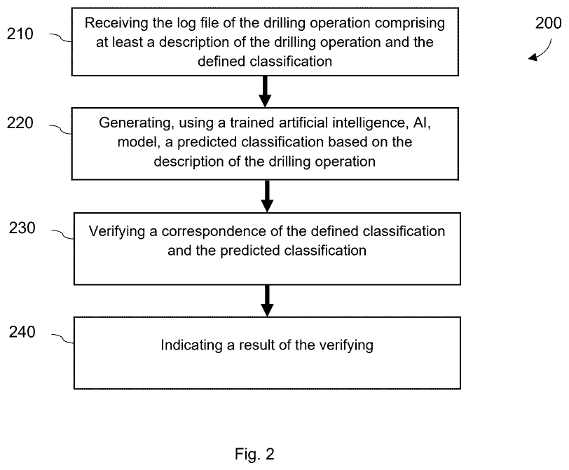

FIG. 2 illustrates a flow chart of a method 200 for verifying a defined classification of a log file of a drilling operation according to aspects of the present invention. The method 200 may be based on the algorithm 100. In step 210, a log file of the drilling operation may be received. Step 210 may refer to the log file 110 of the drilling operation of the algorithm 100.

The log file of the drilling operation may comprise at least a description of the drilling operation and a defined classification for the drilling operation. The description of the drilling operation 110a may be realized by a drilling supervisor and may include a natural language text description. Based on the description, the drilling supervisor may define a classification for the description of the drilling operation. The defined classification may comprise a defined mapping from the description of the drilling operation to at least one operation code of a plurality of operation codes describing drilling operations. Indeed, the operation code may identify a specific drilling operation that occurs. The operation code may comprise a code C_{d} and a subcode SC_{d}.

In step 220, a predicted classification may be generated using a trained AI model based on at least the description of the drilling operation made by the drilling supervisor. In particular, the description used by the trained AI model may be a raw natural language text description written by the the drilling supervisor, which has not been further processed, i.e., no error correction has been conducted, no automated adding of text has been performed, no cleaning has been carried out etc. The trained AI model may be a deep learning model. It may be a neural network preferably a transformer network. Step 220 may refer to the AI workflow 120 of the algorithm 100. The predicted classification may comprise a predicted mapping from the description of the drilling operation to at least one operation code of the plurality of operation codes describing drilling operations. The operation code may comprise a code and a subcode. The step of generating the predicted classification may comprise the step of predicting the code, Cp, from the description of the drilling operation, using a first model and the step of predicting the subcode, SCp, based on the description of the drilling operation and the predicted code Cp, using a second model.

In step 230, a correspondence of the defined classification and the predicted classification may be verified. The step of verifying may comprise comparing the at least one operation code of the defined classification to the at least one operation code of the predicted classification.

In particular, when the defined classification and the predicted classification comprise respectively a defined code C_{d} and subcode SC_{d} and a predicted code Cₚ and subcode SCₚ, the step of comparing the at least one operation code of the defined classification to the at least one operation code of the predicted classification may comprise the steps of: comparing a code C_{d} of the defined classification to the code Cₚ of the predicted classification; and comparing a subcode SC_{d} of the defined classification to the subcode SCₚ of the predicted classification. If the defined code C_{d} is equal to the predicted code Cₚ and the defined subcode SC_{d} is equal to the predicted subcode SCₚ then there is correspondence, and it could be considered that the defined classification is correct. In the event that the defined code C_{d} is not equal to the predicted code Cₚ or that the defined subcode SC_{d} is not equal to the predicted subcode SCₚ, there is no correspondence, and the defined classification may be considered as incorrect or at least there is a probability that the defined classification is incorrect.

In step 240, a result of the verifying may be indicated. The step of indicating the result may comprise sending a warning message when there is no correspondence in the verification step. The warning message may be sent to an application and displayed on a graphical user interface to a user, namely a quality control engineer, or may be sent electronically (e.g., by email) to a quality control engineer.

According to the method, the verification of a correspondence allows checking the consistency of the classification of the description of the drilling operation defined by a drilling supervisor and the predicted classification generated by the AI model. In particular, the step of verifying allows to identify if the defined classification of the description of the drilling operation seems to be correct or incorrect. Therefore, depending on the indication of the result of the verifying, a user, namely the quality control engineer, may control only the description of the drilling operation and the associated defined classification that seems incorrect regarding the prediction. In that case, the user, namely the quality control engineer, may validate the predicted classification based on at least the description of the drilling operation and the predicted classification. According to the present invention, the quality control engineer no longer has to control all the log files and in particular the defined classifications but the ones that are indicated as being potentially incorrect. This accelerates the processing time of the verification of log files and in particular of the defined classifications and saves time for the quality control engineer.

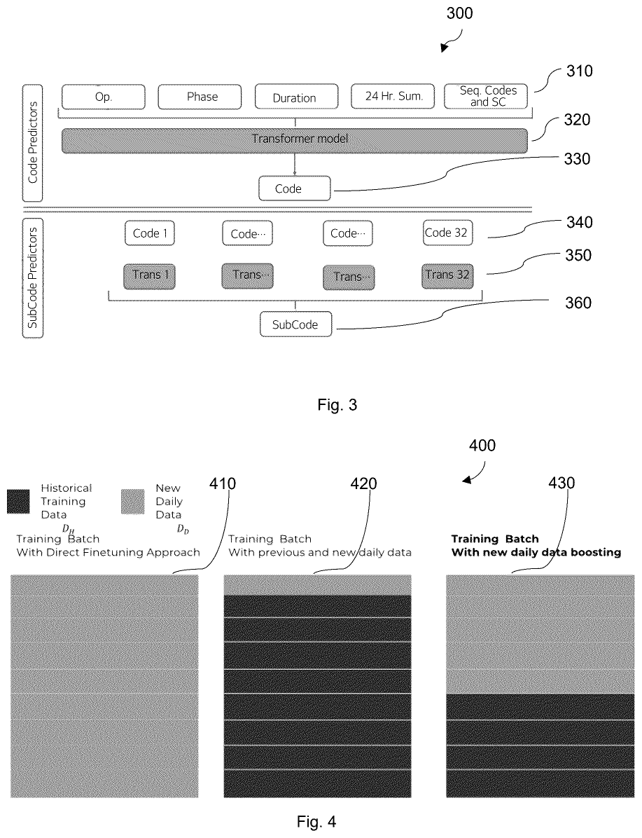

FIG. 3 illustrates input data that may be used by an AI model for use in classifying a drilling operation as input 310 and output data 330, 360 generated by the AI model according to aspects of the present invention. The input data of the AI model may comprise at least a description of the drilling operation comprised in a log file of the drilling operation.

The description of the drilling operation 310 may comprise at least one of the following information as illustrated in FIG. 3: an operation description comprising at least one keyword/label, a drilling phase, a duration of the drilling operation, a summary of a period on time (e.g., the last 24 hours) of the drilling operation including i.e., drilling supervisors'comments, a certain number of previous codes and subcodes, i.e. ten previous codes and subcodes (e.g., codes and subcodes defined for the drilling operation descriptions reported in some log files, the timestamp of these log files being older than the timestamp of the log file) and a certain number of following codes and subcodes, i.e. ten following codes and subcodes (e.g., codes and subcodes defined for the drilling operation descriptions reported in some log files, the timestamp of these log files being younger than the timestamp of the log file).

In the event that the description of the drilling operation comprises more than one information, the information may be concatenated and separated by a specific separator (e.g., the information is surrounded by the following signs <> to separate the information between them).

The description of the drilling operation 310 may include a natural language text description of the drilling operation. According to a specific embodiment, the description of drilling operation may be preprocessed, e.g., by converting it to lower case or by converting it to upper case.

The output of the AI model may comprise a predicted operation code which may comprise a code Cₚ 330 and a subcode SCₚ 360.

As illustrated in FIG. 3, the AI model 300 may have a hierarchical structure which may comprise two levels, a first level which is based on a first model 320 to predict a code mapping a description of a drilling operation and a second level which is based on a second model 350 to predict a subcode mapping the description of the drilling operation and the code. The input data 310 may be inputted into the first model 320 for generating a predicted classification, i.e., a predicted operation code including a code Cₚ 330. Then, based on the predicted code Cₚ generated by the first model 330 and the input data 310, a specific second model 350 may predict a subcode SCₚ 360.

According to the AI model, for each input data of the AI model, only few codes and subcodes may be compatible with a description of a drilling operation, and in particular with the previous and following codes and subcodes comprised in the description.

Based on the structure of the AI model, the second model may be specific to the code predicted by the first model. Therefore, according to this embodiment, for each possible predicted code Cₚ 330, a specific second model 350 is used to predict the subcode 360. In other words, the second model may comprise a plurality of specific second models, each specific second model being specific to a code predicted by the first model. The hierarchical structure of the AI model makes the prediction of a code and a subcode of an operation code easier and more accurate.

The first model 320 and the second model 350, in particular the specific second models, may be neural networks preferably pretrained transformer networks. In some embodiments, the first model and at least some of the specific second models may be RoBerta models. Some of the specific second models may be DistilBert models due to the reduction in necessary capacity and inference time. The choice of the model for the specific second models may be based on experimental results and available data for each specific second model. Cross-entropy may also be used to train the first model and/or the specific second models.

Based on the hierarchical structure of the AI model, predicting a code at first allows to generate a label of higher level than a subcode and also to predict in an easier way a code and a subcode. Indeed, a classification of at least a description of a drilling operation of a log file is easier at the code level than at subcode level improving operation code prediction. In some embodiments, the number of codes is less than the number of subcodes (e.g., which may comprise more than 350 subcodes) so that it is easier to predict a code at first. A set of subcodes being defined for each possible predicted code, predicting a subcode after having predicted a code allows to reduce the potential number of subcodes that may be predicted by focusing only on the subcodes of the predicted code. It also allows to reduce confusion between subcodes. In addition, each specific second model for each code may be developed and trained separately to better handle some challenges, like code imbalance and design specific hyperparameters and architecture for each specific second model.

An AI model used for classifying a drilling operation may be trained according to a computer-implemented method for training an AI model for use in classifying a drilling operation according to aspects of the present invention. Such a method may comprise a step of receiving input training data to train the AI model. The input training data may comprise two sets of training data. A first set of training data may comprise at least one log file describing a drilling operation and a controlled classification, and a second set of training data may comprise at least one recent log file describing a drilling operation and a controlled classification. The training method makes the AI model more robust and accurate.

While during application of the trained AI model, the classification to be predicted is unknown, the classification during training is known to be able to optimize the AI model. Therefore, the corresponding classification may correspond to a controlled classification of at least a description of drilling operation comprised in the log file.

In some embodiments, the training data may continuously be updated once new input data or training data is available. Indeed, new log files of a drilling operation are quality controlled very often. Therefore, some new controlled log files with controlled classification are regularly available. The new log files with controlled classification may be added to the existing training data.

The training data may be used to train the first model and the second model, the second model may comprise specific second models.

The controlled classification of the log file describing a drilling operation and of the at least one recent log file comprised in the training data may include a controlled operation code. The controlled operation code may comprise a controlled code and a controlled subcode. Each second model specific to a code may be trained by using the training data.

The training of the AI model may comprise training a first model to predict a code Cₚ from the description of the drilling operation and a controlled code of the controlled classification of the drilling operation of the at least one log file. The training of the AI model may also comprise training a second model to predict a subcode SCₚ from the description of the drilling operation, the controlled code and a controlled subcode of the controlled classification of the drilling operation of the at least one log file.

The training of the AI model may also include a natural language processing to simulate error and/or amend the description of the drilling operation reported in the at least one log file of the input training data, e.g., data augmentation, for several reasons: the deep learning models tend to overfit because of their large capacity and the hierarchical structure of the AI model which tends to separate the training data according to each specific second model may increase the risk of overfitting. The processing may also include specific processes. Indeed, the description of the drilling operation reported in a log file, being managed, for example by a drilling supervisor, may include a natural language text description of the drilling operation and may be done quickly. The description may then contain some misspelling and/or use some abbreviations. To overcome these issues, data augmentations, preferably, Natural Language Processing (NPL) specific data augmentations, may be used to train the second model, and in particular each of the specific second model. In particular, keyboard augmentation may be used to simulate keyboard distance error, Optical Character Recognition (OCR) augmentation may be used to simulate OCR engine error, word insertion or deletion or swap or substitution augmentations may be used and/or synonym augmentation may be used.

In the event that a low quantity of data is available for each specific second model, these models are pretrained with some weights of the first model able to predict code. It allows faster and better convergence allowing the specific second models to indirectly benefit from the training data of the first model.

As illustrated in FIG. 4, training data to train an AI model may comprise a set of at least one or more recent log files D_{D} describing a drilling operation and a controlled classification 410, or may also comprise a set of at least one or more log files D_{H} describing a drilling operation and a controlled classification 420, 430 which are spaced in time compared to the at least one or more recent log files D_{D}.

The first set of at least one or more log files D_{H} describing a drilling operation and a controlled classification may comprise log files concerning ended drilling project. This set of log files may comprise more than 100.000 drilling operations. The second set of at least one or more recent log files D_{D} describing a drilling operation and a controlled classification may comprise recent log files whose classification has been verified by the verifying method according to the present invention and if necessary, by a quality control engineer. This set of log files may comprise hundreds of operations every day.

The description of the drilling operation being managed by different drilling supervisors, each working on different wells, the description of a same drilling operation may be done by each drilling supervisors, differently (e.g., using different styles). In addition, log files of drilling operation that have been made on a given date Dₜ may be spaced in time compared to log files of the first set of log files D_{H} and may concern different wells and may probably be managed by different drilling supervisors while log files of drilling operation that have been made on the given date Dₜ may be closer in time compared to the log files of the second set of log files D_{D} and may concern the same well. Training the AI model with the second set of log files D_{D} may improve the inference on log files of drilling operation that have been made on a given date Dₜ. To improve the accuracy of the verifying method of a defined classification, the AI model may also be trained by using the set of log files D_{H}, which may contain more controlled log files than the set of log files D_{D} and may be a representative of real distribution of controlled classification. In addition, the set of log files D_{D} may not contain any relevant controlled classification to train the AI model regarding the log files Dₜ. and therefore may not be able to predict classifications that are not in the set of log files D_{D}. Moreover, due to the tendency of an AI model to completely and abruptly forget previously learned information (e.g., information of the set of log files D_{H}) upon learning new information (i.e., catastrophic forgetting of AI model), the training data may be composed of a concatenation of the set of log files D_{D} and the set of log files D_{H}.

The training of the AI model may then be realized by using the concatenated set of log files. Accordingly, the set of log files D_{H} still dominate in quantity the training data. To improve the training method and to prevent the AI model from having learning difficulties, a plurality of batches of training data may be created containing half of log files from the set of log files D_{D} and half of log files from the set of files D_{H} as illustrated in FIG. 4, reference 430. In other words, a number of log files of the first set of training data D_{H} may be equal to a number of recent log files of the second set of training data D_{D}. Using these batches of training data allows the AI model to not remember previously learned information but also to adapt the learned information to newly available training data.

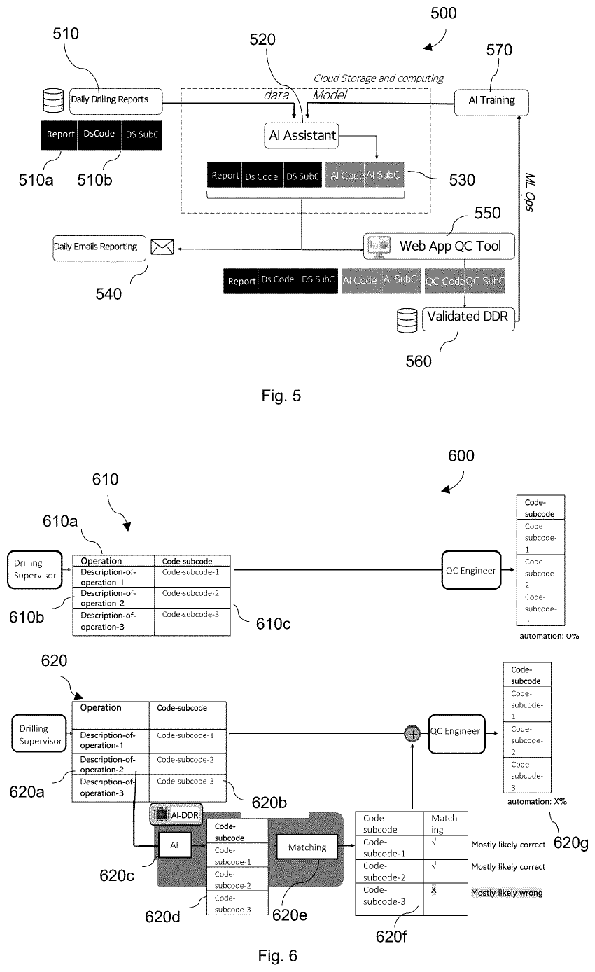

FIG. 5 illustrates an overview of the workflow of a verification of a defined classification of a log file of a drilling operation and of a training of an AI model for use in classifying a drilling operation according to aspects of the present invention. Based on a log file of a drilling operation 510 comprising at least a description of the drilling operation 510a and a defined classification 510b (e.g., comprising an operation code including a code and a subcode defined for example by a drilling supervisor), an AI model 520 may generate a predicted classification 530 (e.g., comprising a predicted operation code including a code and a subcode), based on the description of the drilling operation. The process may be part of an underlying system which is able to execute the AI model and to store the log file and the output of the AI model (e.g., a cloud-based infrastructure comprising a cloud storage and computing). The correspondence of the defined classification 510b and the predicted classification 530 is verifying and a result of the verifying is indicated 540, 550. As illustrated in FIG. 5, the indication may comprise sending a warning message when there is no correspondence in the verification step (e.g., via an email) to one or more users, for example one or more quality control engineers 540 for example on a daily basis and/or may be displayed on a graphical user interface (GUI) which may be part of a web-application 550. The web-app may be part of an underlying system (e.g., a scalable Cloud infrastructure). The GUI may display the log file of the drilling operation comprising at least the description of the drilling operation and the defined classification, as well as the classification predicted by the AI model. Based on the log file, the predicted classification and the indication of the result of the verifying, the quality control engineer may control only log files having a conflictual classification between the defined and the predicted classification that may speed up the engineer time to control log files. In the event of no correspondence between the defined and the predicted classification, the quality control engineer may validate the predicted classification and use it to correct the defined classification, the predicted classification may be considered as a suggested classification that might correct the defined classification. After solving the conflictual classification, the log file with the controlled classification may be validated and submitted in a referential system or storage 560. When there is no conflictual classification, the log file may be submitted directly in the referential system or storage 560. The validated log file may then be used to train the AI model by an AI training engine 570 to minimize its errors for future prediction.

The underlying system (e.g., a cloud-based infrastructure comprising a cloud storage and computing) may be able to execute the AI model and train the AI model in parallel.

FIG. 6 illustrates an overview 600 of an improved workflow according to aspects of the present invention. FIG. 6 illustrates a workflow of a verification of a defined classification of a log file of a drilling operation without the method of the present invention 610. According to this workflow, the quality control engineer may control manually each log file 610a. The log file of a drilling operation illustrated in FIG. 6 comprises three descriptions of the drilling operation 610b and a defined classification for each description 610c. The quality engineer may control manually the defined classification for each description of the drilling operation. The control of the defined classification for each description of the drilling operation may include the control of the code and the subcode of the operation code of the defined classification. No automation process is implemented.

FIG. 6 also illustrates a workflow of an implementation of verification of a defined classification of a log file of a drilling operation with the method of the present invention 620. The log file illustrated in FIG. 6 comprises three descriptions of the drilling operation 620a and a defined classification for each description 620b. Each description of the drilling operation may be inputted into an AI model 620c for generating a predicted classification 620d. For each description of the drilling operation, a verification of a correspondence of the predicted classification and the defined classification may be verified 620e and a result of the verifying may be indicated 620f. The indication allows to identify the defined classification comprised in the log file that is probably wrong. Based on the indication the quality control engineer may only focus on the descriptions of the drilling operation having a probably wrong defined classification and to correct if necessary, the classifications and then obtain controlled classifications 620g.

The aspects according to the present invention may be implemented in terms of a computer program which may be executed on any suitable data processing device comprising means (e.g., a memory and one or more processors operatively coupled to the memory) being configured accordingly. The computer program may be stored as computer-executable instructions on a non-transitory computer-readable medium.

Embodiments of the present disclosure may be realized in any of various forms. For example, in some embodiments, the present invention may be realized as a computer-implemented method, a computer-readable memory medium, or a computer system.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a computing device may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. In particular, with reference to the appended claims, features from dependent claims may be combined with those of the independent claims and features from respective independent claims may be combined in any appropriate manner and not merely in the specific combinations enumerated in the appended claims.

1. A computer-implemented method for verifying a defined classification of a log file of a drilling operation, the method comprises the steps of:
receiving the log file of the drilling operation comprising at least a description of the drilling operation and the defined classification;
generating, using a trained artificial intelligence, AI, model, a predicted classification based on at least the description of the drilling operation;
verifying a correspondence of the defined classification and the predicted classification; and
indicating a result of the verifying.

2. The method of claim 1 wherein the defined classification comprises a defined mapping from the description of the drilling operation to at least one operation code of a plurality of operation codes describing drilling operations; and
wherein the predicted classification comprises a predicted mapping from the description of the drilling operation to at least one operation code of the plurality of operation codes describing drilling operations.

3. The method of claim 2, wherein the operation code comprises a code Cₚ and a subcode SCₚ; and wherein the step of generating the predicted classification comprises the steps of:
predicting the code Cₚ from the description of the drilling operation, using a first model; and
predicting the subcode SCₚ based on the description of the drilling operation and the predicted code, using a second model.

4. The method of claim 2, wherein the step of verifying comprises: comparing the at least one operation code of the defined classification to the at least one operation code of the predicted classification.

5. The method of claim 3, wherein the step of comparing the at least one operation code of the defined classification to the at least one operation code of the predicted classification comprises the steps of:
comparing a code C_{d} of the defined classification to the code Cₚ of the predicted classification; and
comparing a subcode SC_{d} of the defined classification to the subcode SCₚ of the predicted classification.

6. The method of claim 1, wherein the step of indicating the result comprises: sending a warning message when there is no correspondence in the verification step.

7. The method of claim 1, wherein the method further comprises validating the predicted classification by a user when there is no correspondence in the verification step, based on at least the description of the drilling operation and the predicted classification.

8. The method of claim 1, wherein the description of the drilling operation includes a raw natural language text description made by an operator.

9. A computer-implemented method for training an artificial intelligence, AI, model for use in classifying a drilling operation, the method comprising a step of
receiving input training data to train the model comprising two sets of training data:
a first set of training data D_{H} comprising at least one log file describing a drilling operation and a controlled classification, and
a second set of training data D_{D} comprising at least one recent log file describing a drilling operation and a controlled classification.

10. The method of claim 9, wherein a number of log files of the first set of training data D_{H} is equal to a number of recent log files of the second set of training data D_{D}.

11. The method of claim 9, wherein the training of the AI model comprises:
training a first model to predict a code Cₚ from the description of the drilling operation and a controlled code of the controlled classification of the drilling operation of the at least one log file; and
training a second model to predict a subcode SCₚ from the description of the drilling operation, the controlled code and a controlled subcode of the controlled classification of the drilling operation of the at least one log file.

12. The method of claim 9, wherein the training of the AI model includes a natural language processing to simulate error and/or amend the description of the drilling operation reported in the at least one log file.

13. The method of claim 12, wherein the natural language processing comprises data augmentation.

14. The method of claim 1, wherein the description of the drilling operation comprises at least one of an operation description comprising at least one keyword/label, a drilling phase, a duration of the drilling operation, a summary of a period of time of the drilling operation and some codes and/or subcodes.

15. The method of claim 1, wherein the AI model has been trained according to the method of any one of claims 9 to 14.

16. The method of claim 1, wherein, the method comprises determining that new training data is available and training the model by using the new input training data in the following steps:
receiving input training data to train the model comprising two sets of training data:
a first set of training data D_{H} comprising at least one log file describing a drilling operation and a controlled classification, and
a second set of training data D_{D} comprising at least one recent log file describing a drilling operation and a controlled classification.

17. An AI model for use in classifying a drilling operation, the model has a hierarchical structure comprising
a first model to predict a code mapping a description of a drilling operation and
a second model to predict a subcode mapping the description of the drilling operation and the code,
the AI model being trained according to claim 9.

18. The AI model of claim 17, wherein the second model comprise a plurality of specific second models, each specific second model being specific to a code predicted by the first model.

19. The AI model of claim 17 wherein the AI model is implemented by a neural network, preferably a transformer network.

20. A data processing device comprising means configured to perform the method of claim 1.

21. A computer program comprising instructions, which when executed by a computer, causing the computer to perform the method of claim 1.
